(19) United States
(12) Patent Application Publication
(10) Pub. No.: US 2004/0031266 A1
(43) Pub. Date: Feb. 19, 2004

(54) System and method for providing a micro-electro-mechanical microengine assembly

(75) Inventor: Edward S. Kolesar, Fort Worth, TX (US)

Correspondence Address: Docket Clerk, P.O. Drawer 800889, Dallas, TX, 75380, US

(73) Assignee: PC Lens Corp, Dallas, TX

(21) Appl. No.: 10/222,694

(22) Filed: Aug. 16, 2002

(51) Int. Cl. F02G 1/04

(52) U.S. Cl. 60/527

(57) ABSTRACT

A system and method is disclosed for providing a micro-electro-mechanical (MEMS) microengine assembly. In an advantageous embodiment the microengine assembly of the present invention is coupled to the edge of an object. The microengine assembly moves the object by exerting force on the object. The microengine assembly utilizes thermal beam actuator arrays in combination with mechanical links to move a slider unit that is coupled to the object through an aperture in the object. The slider unit is capable of moving the object in a forward direction and in a backward direction by distances as small as one micron (1 μm).

### CROSS-REFERENCE TO RELATED APPLICATIONS

The present invention is related to that disclosed and claimed in the following United States Non-Provisional Patent Applications:

[Docket No. PCLE01-00003], filed concurrently herewith, entitled “SYSTEM AND METHOD FOR FOCUSING AN ELASTICALLY DEFORMABLE LENS.”

[Docket No. PCLE01-00004], filed concurrently herewith, entitled “SYSTEM AND METHOD FOR PROVIDING AN IMPROVED ELECTROTHERMAL ACTUATOR FOR A MICRO-ELECTRO-MECHANICAL DEVICE.”

### TECHNICAL FIELD OF THE INVENTION

This invention generally relates to micro-electro-mechanical systems and, more particularly, to micro-electro-mechanical engines that are capable of moving objects by microscopic distances.

### BACKGROUND OF THE INVENTION

Electrothermal actuators are used in micro-electro-mechanical devices to provide force to move elements of the micro-electro-mechanical device. Electrothermal actuators use ohmic heating (also referred to as Joule heating) to generate thermal expansion and movement. Electrothermal actuators are typically capable of providing lateral deflections of eight microns (8 μm) to ten microns (10 μm). A micron is one millionth of a meter. Electrothermal actuators typically require drive voltages of approximately five volts (5 v). The forces directly exerted by electrothermal actuators may be used to directly move objects by distances of eight microns (8 μm) to ten microns (10 μm).

In some types of applications it is desired to move an object by microscopic distances that are greater than approximately ten microns (10 μm). Moving a microscopic object more than a distance of approximately ten microns (10 μm) cannot be achieved directly using electrothermal actuators.

There is therefore a need in the art for an improved system and method for providing a micro-electro-mechanical (MEMS) microengine assembly that is capable of moving an object by microscopic distances that are larger than ten microns (10 μm).

### SUMMARY OF THE INVENTION

The present invention comprises a system and method for providing a micro-electro-mechanical (MEMS) microengine assembly that is capable of moving an object by microscopic distances. The microengine assembly of the present invention is coupled to the edge of an object and moves the object by exerting force on the object. The microengine assembly comprises an electrothermally actuated microengine and a latching element that couples the microengine to an edge of the object. In response to receiving control signals from a controller, the microengine provides mechanical translations to move the edge of the object in a forward direction or in a backward direction.

The microengine assembly is capable of functioning in two distinct modes. In the first mode, the microengine assembly is capable of producing macroscopic mechanical translations on the order of two hundred microns (200 μm) in order to engage the latching element of the microengine assembly with an aperture through the object. In the second mode, the microengine assembly is capable of producing microscopic mechanical translations on the order of one micron (1 μm).

It is an object of the present invention to provide a system and method providing a micro-electro-mechanical (MEMS) microengine assembly that is capable of moving an object by microscopic distances.

It is another object of the present invention to provide a system and method providing a micro-electro-mechanical (MEMS) microengine assembly that is capable of moving an object by a microscopic distance that is greater than ten microns (10 μm).

It is also an object of the present invention to provide a system and method for providing an electrothermally actuated micro-electro-mechanical (MEMS) microengine assembly that comprises a microengine and a latching unit.

It is another object of the present invention to provide a controller to send control signals to operate an electrothermally actuated micro-electro-mechanical (MEMS) microengine assembly.

It is another object of the present invention to provide a system and method for providing a plurality of micro-electro-mechanical (MEMS) microengine assemblies that are capable of moving an object by microscopic distances.

Further objects of the invention will become apparent from the description of the invention that follows.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a perspective view of a prior art thermal beam actuator;

FIG. 2 illustrates a plan view of the thermal beam actuator shown in FIG. 1;

FIG. 3 illustrates a cross sectional view of the thermal beam actuator shown in FIG. 2 taken along line A-A;

FIG. 4 illustrates a plan view of the thermal beam actuator shown in FIG. 1 showing how a thermal beam actuator may be deflected in a forward direction in a basic “thermo-elastic” deflection mode;

FIG. 5 illustrates a plan view of the thermal beam actuator shown in FIG. 1 showing how a thermal beam actuator may be deflected in a backward direction in an alternate “thermo-plastic” deflection mode;

FIG. 6 illustrates a plan view of the thermal beam actuator shown in FIG. 1 and a parallel cantilever beam for measuring lateral deflections of the thermal beam actuator;

FIG. 7 illustrates an enlarged view of the free end of the thermal beam actuator and the free end of the cantilever beam shown in FIG. 6 and a deflection scale for measuring the deflection of the ends of the thermal beam actuator and the cantilever beam;

FIG. 8 illustrates a plan view of a thermal beam actuator array comprising a plurality of prior art thermal beam actuators;

FIG. 9 illustrates an electrothermally actuated microengine and latching unit of the present invention;

FIG. 10 illustrates a detailed view of a translation unit of the electrothermally actuated microengine shown in FIG. 9;

FIG. 11 illustrates a controller for providing control signals to control the operation of an electrothermally actuated microengine of the present invention;

FIG. 12 illustrates a detailed view of a latching unit of an electrothermally actuated microengine of the present invention;

FIG. 13 illustrates a latching unit of an electrothermally actuated microengine of the present invention located adjacent to an object having an aperture to receive the latching unit of the electrothermally actuated microengine of the present invention;

FIG. 14 illustrates a cross sectional view of the object shown in FIG. 13 showing how a latching unit of the microengine of the present invention may be attached through the aperture of the object;

FIG. 15 illustrates an exemplary circuit for controlling the operation of a microengine of the present invention to move an object in accordance with the principles of the present invention;

FIG. 16 illustrates three exemplary microengine assemblies attached to an object through apertures located adjacent to an edge of the object; and

FIG. 17 illustrates a flow diagram of an advantageous embodiment of a method for operating an electrothermally actuated microengine and latching unit in accordance with the principles of the present invention.

### DETAILED DESCRIPTION OF THE INVENTION

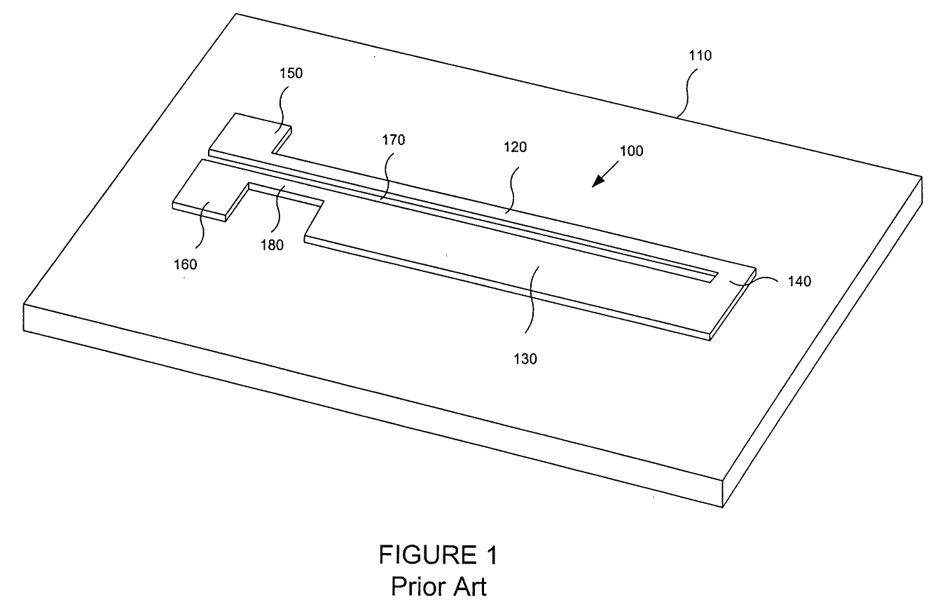

FIGS. 1 through 16, discussed below, and the various embodiments used to describe the principles of the present invention in this patent document are by way of illustration only and should not be construed in any way to limit the scope of the invention. Those skilled in the art will understand that the principles of the present invention may be implemented using any suitable type of electrothermally actuated microengine assembly.

The improved system and method of the present invention is capable of accurately moving an object by very small distances. The microengine assembly of the present invention utilizes micro-electro-mechanical system (MEMS) devices that are capable of generating tensile and compressive forces on the order of five to fifteen microNewtons (5 μN to 15 μN). These forces are capable of accurately moving an object by distances as small as one micron (1 μm).

As will be more fully described, one advantageous embodiment of the present invention comprises a plurality of microengine assemblies, each of which is coupled to an edge of an object to be moved. Each microengine assembly comprises an electrothermally actuated microengine and a latching element that couples the microengine to an edge of the object. In response to receiving control signals from a controller, each microengine provides mechanical force to move the object either forward or backward.

Each microengine assembly is capable of functioning in two distinct modes. In the first mode, each microengine assembly is capable of producing macroscopic mechanical translations on the order of two hundred microns (200 μm) in order to engage the latching element of the microengine assembly with an aperture through the object. In the second mode, each microengine assembly is capable of producing microscopic mechanical translations on the order of one micron (1 μm) in order to move the object.

Electrothermal actuators are used in micro-electro-mechanical devices to provide force to move elements of the micro-electro-mechanical device. Electrothermal actuators use ohmic heating (also referred to as Joule heating) to generate thermal expansion and movement. Electrothermal actuators are typically capable of providing lateral deflections of eight microns (8 μm) to ten microns (10 μm). A micron is one millionth of a meter. Electrothermal actuators typically require drive voltages of approximately five volts (5 v).

FIG. 1 illustrates a perspective view of a prior art thermal beam actuator 100 mounted on a dielectric substrate 110. Micro-electro-mechanical systems (MEMS) technology is used to form thermal beam actuator 100 from a layer of polysilicon deposited on a dielectric substrate 110 such as silicon nitride. The components of thermal beam actuator 100 are formed from a common layer of polysilicon.

Thermal beam actuator 100 comprises first arm 120 and second arm 130. First arm 120 and second arm 130 are joined together at one end with a rigid polysilicon mechanical link 140. The end of thermal beam actuator 100 that comprises mechanical link 140 is able to move laterally and parallel to the surface of substrate 110. This end of thermal beam actuator 100 is therefore referred to as the “free” end.

The other end of first arm 120 is coupled to anchor 150 and the other end of second arm 130 is coupled to anchor 160. Anchor 150 and anchor 160 are in turn coupled to substrate 110. This end of thermal beam actuator 100 is therefore referred to as the “fixed” end.

As shown in FIG. 1, thermal beam actuator 100 is formed having portions that define a gap 170 between first arm 120 and second arm 130. Gap 170 is formed by an interior edge of first arm 120 and by an interior edge of second arm 130. The width of gap 170 is determined by the width of mechanical link 140. Air in gap 170 provides electrical insulation between first arm 120 and second arm 130.

The width of second arm 130 is greater than the width of first arm 120 for most of the length of thermal beam actuator 100. As shown in FIG. 1, thermal beam actuator 100 is formed having portions that define a flexure portion 180 of second arm 130. Flexure portion 180 usually has a width that is the same width as first arm 120. A first end of flexure portion 180 is attached to anchor 160 and a second end of flexure portion 180 is attached to the end of the wide portion of second arm 130 that is adjacent to flexure portion 180.

Electric current (from an electrical source not shown in FIG. 1) may be passed through anchor 150, through first arm 120, through mechanical link 140, through second arm 130, through flexure portion 180, through anchor 160, and back to the electrical source. Alternatively, electric current (from an electrical source not shown in FIG. 1) may be passed through anchor 160, through flexure portion 180, through second arm 130, through mechanical link 140, through first arm 120, through anchor 150, and back to the electrical source.

Because the width of first arm 120 is narrower than the width of second arm 130 (with the exception of flexure portion 180), the current density in first arm 120 will be greater than the current density in the wider portion of second arm 130. The larger current density in first arm 120 causes first arm 120 to become hotter than second arm 130. For this reason first arm 120 is sometimes referred to as a “hot” arm 120 and second arm 130 is sometimes referred to as a “cold” arm 130. The higher level of heat in first arm 120 causes the thermal expansion of first arm 120 to be greater than the thermal expansion of second arm 130.

Because first arm 120 and second arm 130 are joined at the free end of thermal beam actuator 100 by mechanical link 140, the differential expansion of first arm 120 and second arm 130 causes the free end of thermal beam actuator 100 to move in an arc-like trajectory parallel to the surface of substrate 110. When the electric current is switched off, the heating of first arm 120 and second arm 130 ceases. Then first arm 120 and second arm 130 cool down. As first arm 120 and second arm 130 cool down they return to their equilibrium positions.

The essential requirement for generating deflection in thermal beam actuator 100 is to have one arm expand more than the other arm. Prior art thermal beam actuators such as thermal beam actuator 100 are capable of producing lateral deflections (i.e., deflections parallel to the plane of substrate 110) on the order of five microns (5.0 μm) with typical drive voltages that are less than seven volts (7.0 v).

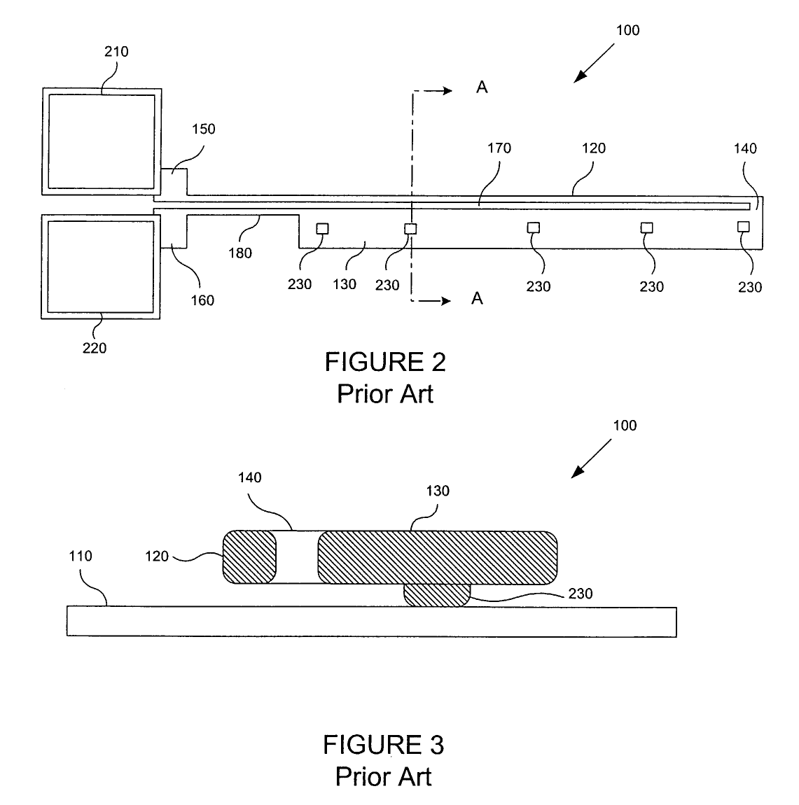

FIG. 2 illustrates a schematic plan view of thermal beam actuator 100. Anchor 150 is coupled to electrical connector 210 and anchor 160 is coupled to electrical connector 220. Electrical connector 210 and electrical connector 220 are coupled to a source of electric current (not shown in FIG. 2). Portions of the surface of second arm 130 adjacent to substrate 110 are formed into a plurality of support dimples 230 spaced along the length of second arm 130. The plurality of support dimples 230 position second arm 130 above substrate 110 and serve as near frictionless bearings as second arm 130 moves laterally across the surface of substrate 110. An exemplary placement of the plurality of support dimples 230 along second arm 130 is shown in FIG. 2. Although the support dimples 230 are located under second arm 130, they are shown in FIG. 2 in solid outline (rather than in dotted outline) for clarity.

FIG. 3 illustrates a cross sectional view of thermal beam actuator 100 taken along line A-A of FIG. 2. FIG. 3 shows how second arm 130 is positioned above substrate 110 by the plurality of support dimples 230.

Thermal beam actuator 100 may be constructed using the following typical dimensions. First arm 120 is one hundred ninety microns (190 μm) long, two microns (2 μm) wide, and two microns (2 μm) thick. Flexure portion 180 of second arm 130 is forty microns (40 μm) long, two microns (2 μm) wide, and two microns (2 μm) thick. The remaining portion of second arm 130 is one hundred fifty microns (150 μm) long, fifteen microns (15 μm) wide, and two microns (2 μm) thick. The width of gap 170 determined by mechanical link 140 is two microns (2 μm). Each support dimple 230 is five microns (5 μm) long, five microns (5 μm) wide, and one micron (1 μm) thick. Anchor 150 and anchor 160 are each fifteen microns (15 μm) long and fifteen microns (15 μm) wide. Electrical connector 210 and electrical connector 220 are each one hundred microns (100 μm) long and one hundred microns (100 μm) wide. These dimensions are exemplary. Other dimensions may be used to construct thermal beam actuator 100.

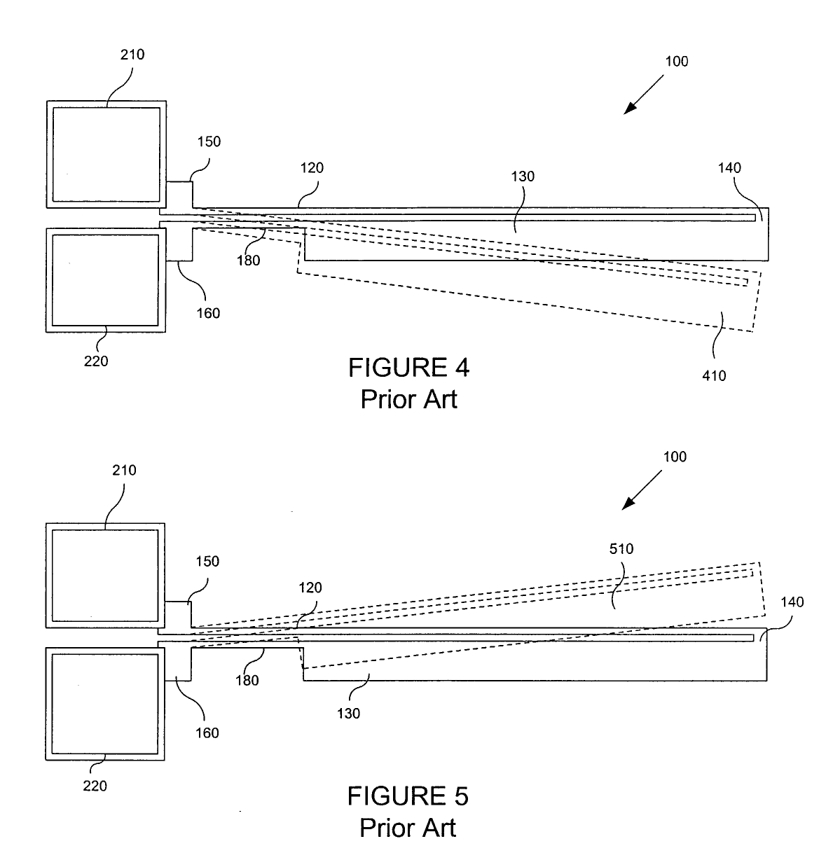

As shown in FIG. 4 and in FIG. 5, thermal beam actuator 100 can be operated in two modes. In the basic “thermo-elastic” mode (illustrated in FIG. 4) electric current is passed through thermal beam actuator 100 from electrical connector 210 to electrical connector 220 (or vice versa). The higher current density in first arm 120 (the narrower hot arm) causes it to heat and expand more than second arm 130 (the wider cold arm). As previously explained, the differential expansion of first arm 120 and second arm 130 causes the free end of thermal beam actuator 100 to move in an arc about flexure portion 180 that is attached to anchor 160. The deflected position of thermal beam actuator 100 is shown in dotted outline 410 in FIG. 4. Switching off the electric current allows thermal beam actuator 100 to return to its equilibrium state.

The alternate “thermo-plastic” mode of operation (illustrated in FIG. 5) is used to create a permanent deformation in first arm 120 (the narrower hot arm) of thermal beam actuator 100. The permanent deformation is accomplished by supplying enough electric current to cause plastic deformation of the polysilicon of first arm 120. In general, the amount of electric current necessary to create a permanent deformation of first arm 120 is slightly higher than the electric current needed to generate the maximum deflection of the end of thermal beam actuator 100. When the electric current is switched off, thermal beam actuator 100 is left permanently “back bent” from its original position due to bowing or buckling of first arm 120. The amount of deformation or “back bending” depends on the amount of over-current that is applied. The “back bent” position of thermal beam actuator 100 is shown in dotted outline 510 in FIG. 5. After back bending, thermal beam actuator 100 can be operated in the basic “thermo-elastic” mode. Back bending is particularly useful for the one time positioning of thermal beam actuator 100 and as a tool for the assembly of complex devices.

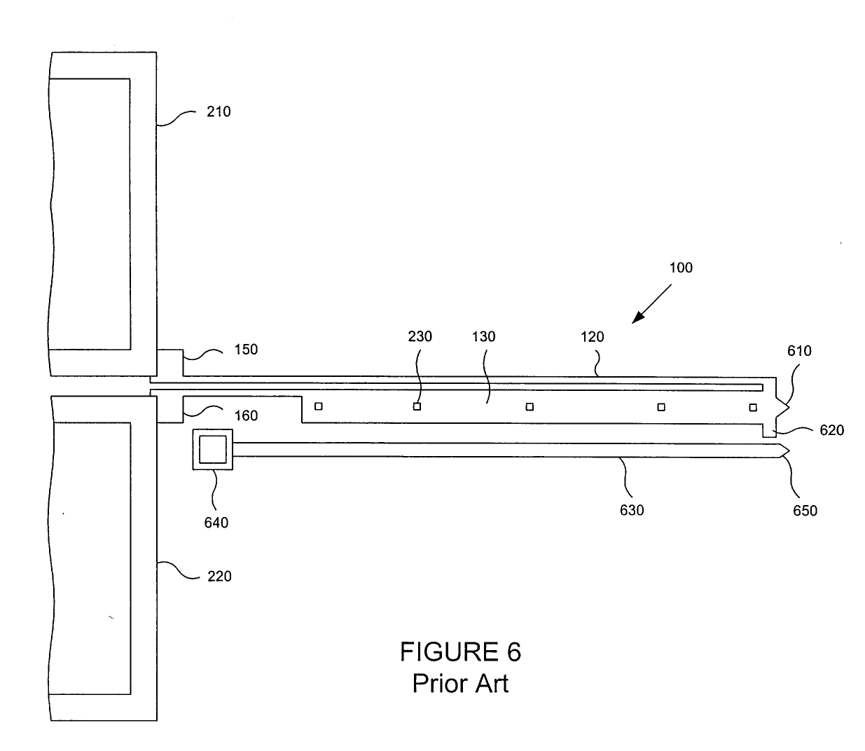

FIG. 6 illustrates how a cantilever beam 630 may be used to experimentally measure the force that can be generated at the free end of activated thermal beam actuator 100. Cantilever beam 630 is positioned parallel to second arm 130 and affixed to anchor 640 which is in turn affixed to substrate 110. Cantilever beam 630 is typically five microns (5 μm) wide. One micron (1 μm) square support dimples (not shown) are placed under cantilever beam 630 to support cantilever beam 630 above substrate 110 and to minimize frictional losses as cantilever beam 630 is moved across the surface of substrate 110 by thermal beam actuator 100.

As shown in FIG. 6, second arm 130 of thermal beam actuator 100 is formed having portions that define a pointed tip 610 to facilitate a measurement of the amount of deflection of the free end of thermal beam actuator 100. Similarly, the free end of cantilever beam 630 is formed into a pointed tip 650 to facilitate a measurement of the amount of deflection of cantilever beam 630. Second arm 130 of thermal beam actuator 100 is also formed having portions that define a contact extension 620 for abutting cantilever beam 630 when thermal beam actuator 100 is deflected. The physical gap between contact extension 620 and cantilever beam 630 is typically two microns (2 μm).

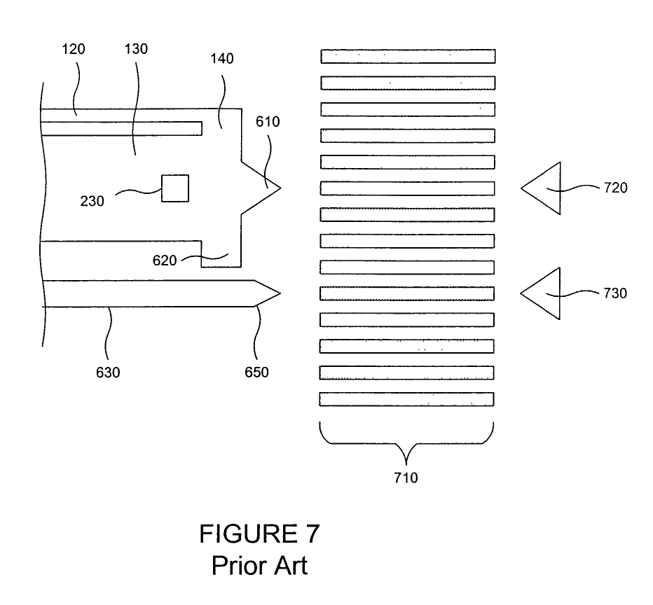

FIG. 7 illustrates a deflection scale 710 for measuring the deflection of thermal beam actuator 100 and cantilever beam 630. Deflection scale 710 is fabricated on the surface of substrate 110. The scale marking of deflection scale 710 are typically two microns (2 μm) wide. Deflection scale thermal beam indicator 720 fabricated on the surface of substrate 110 marks the equilibrium position of thermal beam actuator 100. Deflection scale cantilever beam indicator 730 fabricated on the surface of substrate 110 marks the equilibrium position of cantilever beam 630.

Activation of thermal beam actuator 100 causes second arm 130 to deflect toward cantilever beam 630. Deflection of second arm 130 causes contact extension 620 to abut cantilever beam 630 and to deflect cantilever beam 630. The deflection of thermal beam actuator 100 and the deflection of cantilever beam 630 are accurately measured by observing the position of tip 610 and tip 650 on deflection scale 710. In this manner it is possible to measure the magnitude of tip deflection versus applied electric current and power. This information enables one to obtain the amount of force “F” (in micro Newtons) exerted by thermal beam actuator 100 on cantilever beam 630 using the following equation:

$$F = \frac{E h}{4} {( \frac{b }{k} )}^{3} d \qquad ( 1 )$$

where “F” is the force applied to cantilever beam 630, “E” is the Young's modulus of elasticity of cantilever beam 630, “h” is the width of cantilever beam 630, “b” is the thickness of cantilever beam 630, “k” is the suspended length of cantilever beam 630, and “d” is the deflection of cantilever beam 630. Equation (1) ignores losses due to friction as cantilever beam 630 moves across the surface of substrate 110.

Consider a thermal beam actuator 100 having the following dimensions. First arm 120 is two hundred microns (200 μm) in length, two microns (2 μm) in width and two microns (2 μm) in thickness. Second arm 130 is one hundred seventy microns (170 μm) in length, fourteen microns (14 μm) in width and two microns (2 μm) in thickness. Flexure portion 180 is thirty microns (30 μm) in length, two microns (2 μm) in width and two microns (2 μm) in thickness. A typical applied voltage of four and three tenths volts (4.3 v) produces an applied current of three and eight tenths milliamps (3.8 mA) and an applied power of sixteen and three tenths milliwatts (16.3). This causes the tip of thermal beam actuator 100 to be deflected by eight microns (8 μm)

When thermal beam actuator 100 deflects cantilever beam 630 by eight microns (8 μm), the value of “d” in Equation (1) is eight microns (8 μm). Equation (1) may then be used to calculate that a deflection of eight microns (8 μm) corresponds to a force of four micro Newtons (4 μN) exerted by thermal beam actuator 100.

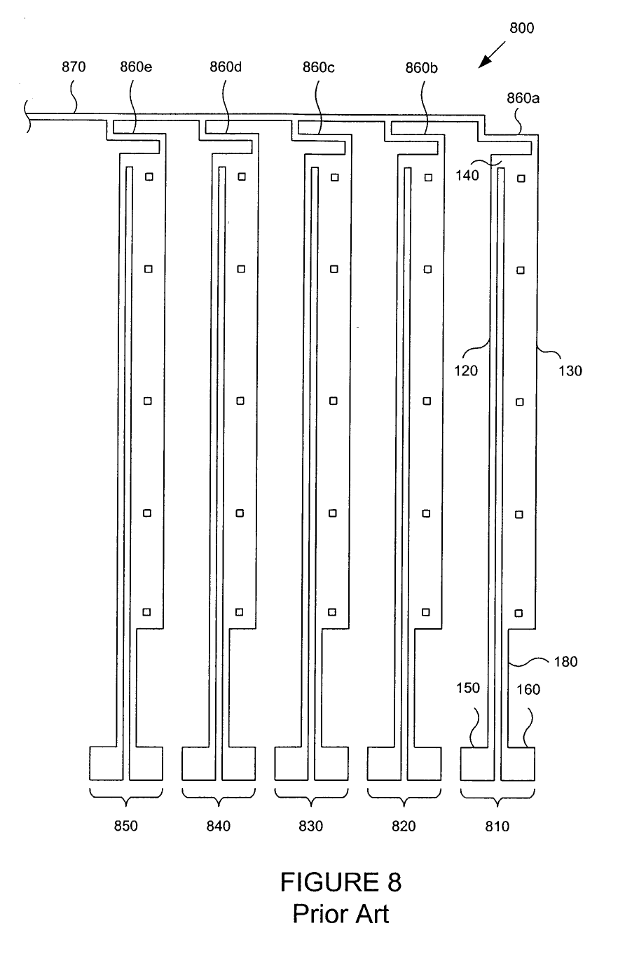

An array of thermal beam actuators may be used in applications that require more force than a single thermal beam actuator can supply or when linear motion is required. FIG. 8 provides an example of how a plurality of prior art thermal beam actuators (810, 820, 830, 840, 850) may be grouped together to form a thermal beam actuator array 800. The free end of each thermal beam actuator in array 800 is formed having portions that define a connecting link (860a, 860b, 860c, 860d, 860e) that is coupled to a common mechanical yoke 870. The combined force exerted by the thermal beam actuators in array 800 is exerted on mechanical yoke 870. Mechanical yoke 870 is a critical component in thermal beam actuator array 800 because it combines the motion and the force of the thermal beam actuators in array 800 in a linear deflection. Each thermal beam actuator in thermal beam actuator array 800 comprises a thermal beam actuator 100.

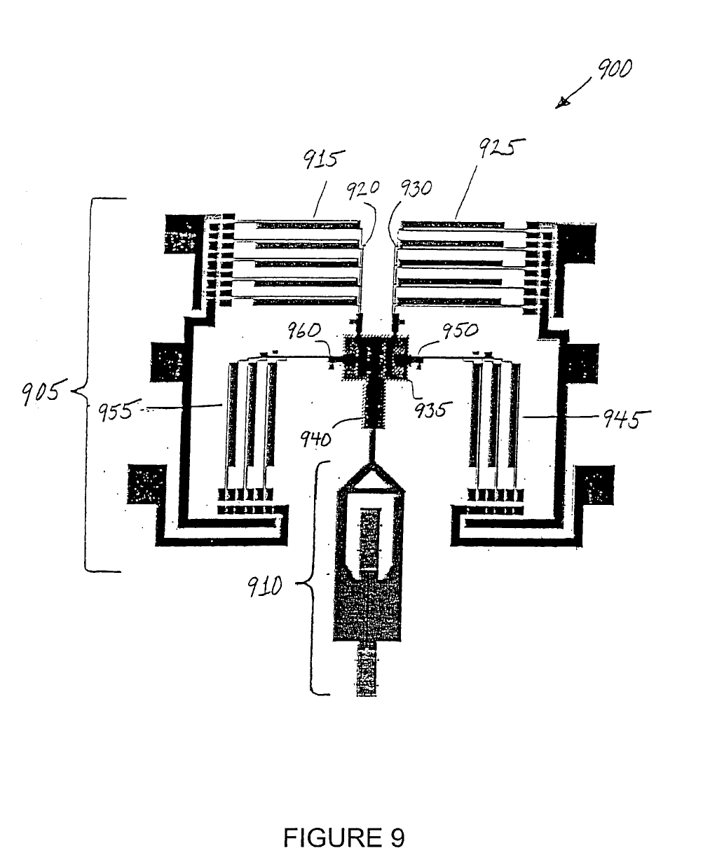

Thermal beam actuator arrays may be used to construct an electrothermally actuated microengine. FIG. 9 illustrates an exemplary electrothermally actuated microengine 905 coupled to an exemplary latching unit 910. The combination of microengine 905 and latching unit 910 will be collectively referred to as microengine assembly 900.

Microengine 905 comprises first thermal beam actuator array 915, second thermal beam actuator array 925, third thermal beam actuator array 945, and fourth thermal beam actuator array 955. Second thermal beam actuator array 925 is designed to deflect in a direction that is opposite to the direction of deflection of first thermal beam actuator array 915. Fourth thermal beam actuator array 955 is designed to deflect in a direction that is opposite to the direction of deflection of third thermal beam actuator array 945. As will be more fully described, the operation of thermal beam actuator arrays 915, 925, 945 and 955 provide linear motion to latching unit 910.

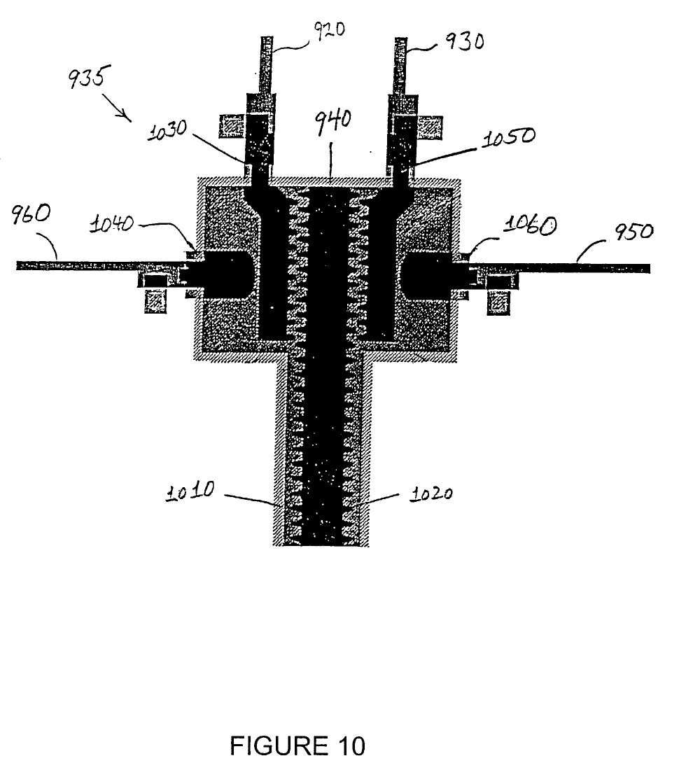

Microengine 905 comprises a translation unit 935 that is capable of utilizing the microforces that are generated by the thermal beam actuator arrays 915, 925, 945 and 955. The operation of microengine 905 may be understood by considering the operation of translation unit 935. The structure of translation unit 935 is shown in detail in FIG. 10. Translation unit 935 comprises a centrally disposed slider unit 940 having a first geared edge 1010 on one side and a second geared edge 1020 on an opposite side. As shown in FIG. 9, slider unit 940 is coupled to latching unit 910. Latching unit 910 moves in response to the movement of slider unit 940.

Translation unit 935 comprises a geared pawl 1030 that is coupled to mechanical yoke 920 of first thermal beam actuator array 915. Translation unit 935 also comprises engagement member 1040 that is coupled to mechanical yoke 960 of fourth thermal beam actuator array 955. When engagement member 1040 is moved laterally into contact with geared pawl 1030, geared pawl 1030 engages first geared edge 1010 of slider unit 940. When engagement member 1040 is moved laterally out of contact with geared pawl 1030, geared pawl 1030 disengages first geared edge 1010 of slider unit 940.

Translation unit 935 also comprises a geared pawl 1050 that is coupled to mechanical yoke 930 of second thermal beam actuator array 925. Translation unit 935 also comprises engagement member 1060 that is coupled to mechanical yoke 950 of third thermal beam actuator array 945. When engagement member 1060 is moved laterally into contact with geared pawl 1050, geared pawl 1050 engages second geared edge 1020 of slider unit 940. When engagement member 1060 is moved laterally out of contact with geared pawl 1050, geared pawl 1050 disengages second geared edge 1010 of slider unit 940.

In order to move latching unit 910 forward (i.e., downwardly with respect to FIG. 9) fourth thermal beam actuator array 955 is activated to laterally move engagement member 1040 into contact with geared pawl 1030 to cause geared pawl 1030 to engage first geared edge 1010 of slider unit 940. Then first thermal beam actuator array 915 is activated to move mechanical yoke 920 and geared pawl 1030 in a forward direction (i.e., downwardly with respect to FIG. 9). This in turn causes slider unit 940 and latching unit 910 to move in a forward direction.

When slider unit 940 and latching unit 910 have been moved to a desired location, third thermal beam actuator array 945 is activated to laterally move engagement member 1060 into contact with geared pawl 1050 to cause geared pawl 1050 to engage second geared edge 1020 of slider unit 940. This locks slider unit 940 into position and stabilizes the position of latching unit 910. First thermal beam actuator array 915 and fourth thermal beam actuator array 955 are then deactivated.

By systematically repeating this process in rapid succession, latching unit 910 can be rapidly moved by macroscopic amounts (e.g., by amounts up to as much as two hundred microns (200 μm)). Alternatively, when microscopic movements are required (e.g., when discrete steps determined by the dimensions of the gear teeth of slider unit 940 are required), a decrease in the magnitude of the excitation voltage applied to the thermal beam actuator arrays responsible for the forward motion of latching unit 910 will correspondingly reduce the magnitude of the movement (e.g., one micron (1 μm) or less). When a desired location for latching unit 910 is achieved, both geared pawl 1030 and geared pawl 1050 may be engaged to lock latching unit 910 into position.

To cause latching unit 910 to move in the opposite direction (i.e., in a backwards direction) the steps of the process described above are repeated using second thermal beam actuator array 925 and third thermal beam actuator array 945. Specifically, in order to move latching unit 910 backwards (i.e., upwardly with respect to FIG. 9) third thermal beam actuator array 945 is activated to laterally move engagement member 1060 into contact with geared pawl 1050 to cause geared pawl 1050 to engage second geared edge 1020 of slider unit 940. Then second thermal beam actuator array 925 is activated to move mechanical yoke 930 and geared pawl 1050 in a backwards direction (i.e., upwardly with respect to FIG. 9). This in turn causes slider unit 940 and latching unit 910 to move in a backwards direction.

When slider unit 940 and latching unit 910 have been moved to a desired location, fourth thermal beam actuator array 955 is activated to laterally move engagement member 1040 into contact with geared pawl 1030 to cause geared pawl 1030 to engage first geared edge 1010 of slider unit 940. This locks slider unit 940 into position and stabilizes the position of latching unit 910. Second thermal beam actuator array 925 and third thermal beam actuator array 945 are then deactivated.

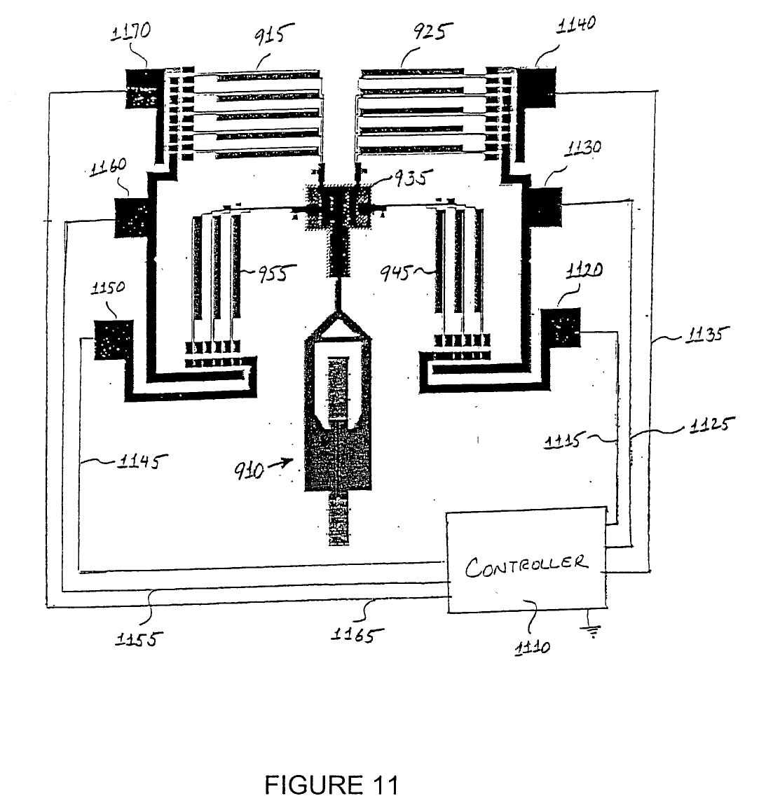

FIG. 11 illustrates a controller 1110 for providing control signals to control the operation of microengine 905. The control signals from controller 1110 activate and deactivate the thermal beam actuator arrays of microengine 905 as described above to provide linear motion to latching unit 910.

As shown in FIG. 11, electrical contact pad 1170 and electrical contact pad 1160 provide electrical connections to operate first thermal beam actuator array 915. Electrical contact pad 1140 and electrical contact pad 1130 provide electrical connections to operate second thermal beam actuator array 925. Electrical contact pad 1130 and electrical contact pad 1120 provide electrical connections to operate third thermal beam actuator array 945. Electrical contact pad 1160 and electrical contact pad 1150 provide electrical connections to fourth thermal beam actuator array 945.

Control signal line 1115 couples controller 1110 and electrical contact pad 1120. Control signal line 1125 couples controller 1110 and electrical contact pad 1130. Control signal line 1135 couples controller 1110 and electrical contact pad 1140.

Similarly, control signal line 1145 couples controller 1110 and electrical contact pad 1150. Control signal line 1155 couples controller 1110 and electrical contact pad 1160. Control signal line 1165 couples controller 1110 and electrical contact pad 1170.

Controller 1110 is capable of sending control signals through a control signal line (1115, 1125, 1135, 1145, 1155, 1165) to its respective electrical contact pads (1120, 1130, 1140, 1150, 1160, 1170) of microengine 905. In one embodiment of the invention, the control signals from controller 1110 are voltage signals. In an alternate embodiment of the invention, the control signals from controller 1110 are current signals. By sending an appropriate set of control signals controller 1110 is capable of macroscopically or microscopically adjusting the position of latching unit 910 by moving slider unit 940 in the manner previously described.

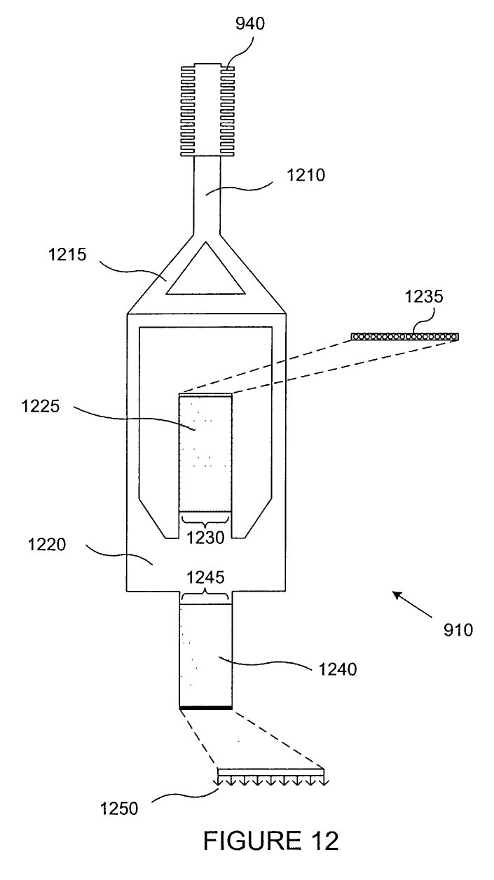

FIG. 12 illustrates a detailed view of latching unit 910 of the present invention. The original unfolded structure of latching unit 910 is generally a flat polysilicon structure. Latching unit 1240 comprises a first hinge plate 1225 and a second hinge plate 1240 that fold up out of the plane of latching unit 910. The other portions of latching unit 910 are planar in that they do not move out of the original plane of latching unit 910.

Latching unit 910 comprises a first plate portion 1210, a yoke 1215, and a frame portion 1220. One end of first plate portion 1210 is coupled to slider unit 940. The other end of first plate portion 1210 is coupled to yoke 1215. Yoke 1215 in turn is rigidly coupled to frame portion 1220. That is, yoke 1215 does not fold or bend with respect to the plane of frame portion 1220.

Frame portion 1220 is formed having portions that define a first hinge plate 1225 and a second hinge plate 1240. First hinge plate 1225 may be folded upwardly from frame portion 1220 along hinge line 1230. The distal end of first hinge plate 1225 is formed having portions that define a plurality of latching windows 1235. Latching windows 1235 are adapted to receive a plurality of latching units 1250 on the distal end of second hinge plate 1240.

Second hinge plate 1240 may be folded upwardly from frame portion 1220 along hinge line 1245. The distal end of second hinge plate 1240 is formed having portions that define a plurality of latching units 1235 that are designed to be received by the plurality of latching windows 1235 on the distal end of first hinge plate 1225.

Latching units 1250 may be in the form of arrowheads, microrivets, or other similar structures that are capable of deforming (i.e., changing their shape) when being passed through latching windows 1235 and reforming (i.e., regaining their shape) after they have passed through latching windows 1235. In this manner the latching units 1250 form a secure connection with the latching windows 1235. This ensures that the distal end of first hinge plate 1225 and the distal end of second hinge plate 1240 remain securely connected.

A triangular passageway formed by the surface of frame portion 1220, and the surface of first hinge plate 1225, and the surface of second hinge plate 1240 enables latching unit 910 to be secured to another structure (not shown in FIG. 12). Placing first hinge plate 1225 and second hinge plate 1240 around a structure and securing the distal ends as described above provides a mechanical gripper for attaching microengine 905 to the structure.

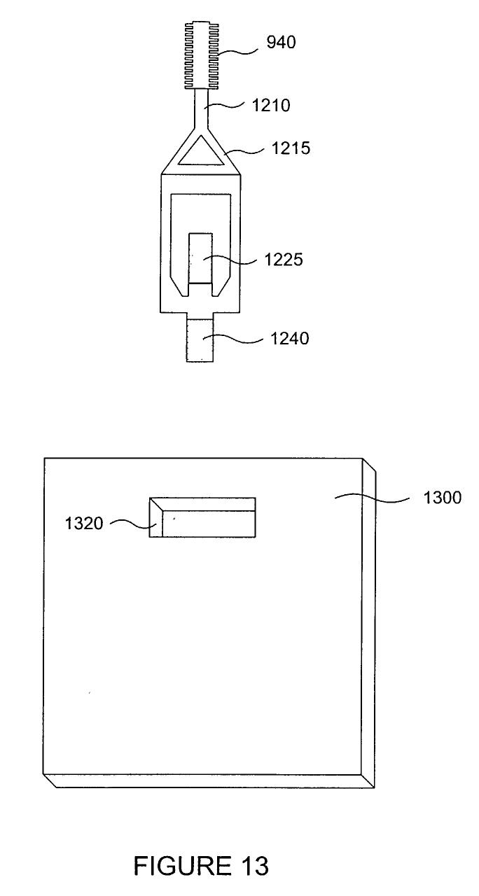

FIG. 13 illustrates a latching unit 910 of microengine assembly 900 that is located adjacent to object 1300. Object 1300 is an exemplary body that represents a macroscopic load that may be moved by microengine assembly 900. Object 1300 is only one example of a macroscopic load and it is understood that other types of macroscopic loads may also be used. Object 1300 has portions that define an aperture 1320 for receiving the latching unit 910 of microengine assembly 900.

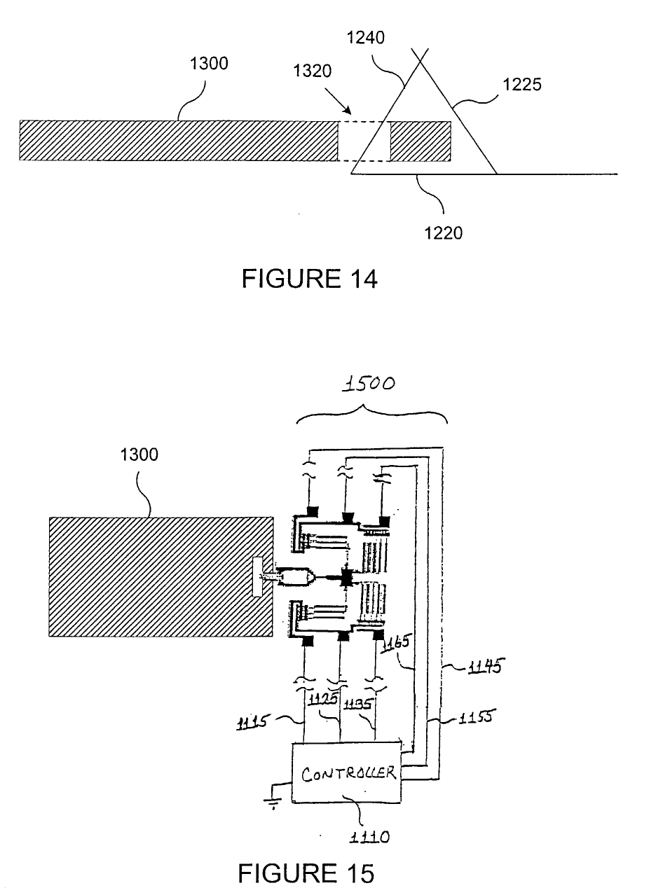

FIG. 14 illustrates a cross sectional view of object 1300 showing how latching unit 910 of microengine assembly 900 may be attached through aperture 1320 of object 1300. As shown in FIG. 14, a triangular passageway formed by the surface of frame portion 1220, and the surface of first hinge plate 1225, and the surface of second hinge plate 1240 enables latching unit 910 to be secured to object 1300 through aperture 1320. To attach latching unit 910 to object 1300 second hinge plate 1240 is folded upward from frame portion 1220 and passed through aperture 1320. First hinge plate 1225 is folded up from frame portion 1220 and the distal end of first hinge plate 1225 is secured to the distal end of second hinge plate 1240 while second hinge plate 1240 is within aperture 1320. This securely couples latching unit 910 (and microengine 905) to one edge of object 1300.

FIG. 15 illustrates an exemplary circuit 1500 for controlling the operation of microengine assembly 900 when microengine assembly 900 is connected to object 1300. In the exemplary circuit 1500 shown in FIG. 15, controller 1110 sends one or more control signals to microengine 905 to move object 1300 by changing the position of latching unit 910. Circuit 1500 operates using control signals in the manner previously described with reference to FIG. 11.

As previously described, microengine assembly 900 is capable of functioning in two distinct modes. In the first mode, microengine assembly 900 is capable of producing macroscopic mechanical translations on the order of two hundred microns (200 μm) in order to engage latching element 910 of microengine assembly 900 with aperture 1320 through object 1300. In the second mode, microengine assembly 900 is capable of producing microscopic mechanical translations on the order of one micron (1 μm) in order to move object 1300 microscopic distances.

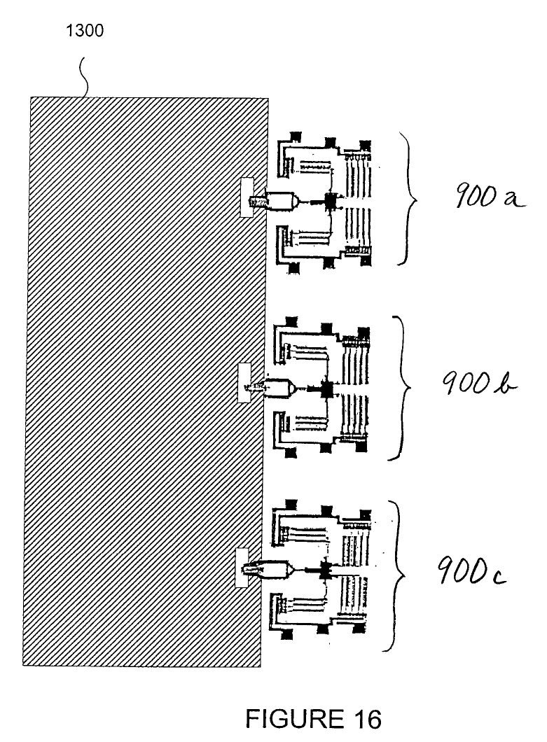

FIG. 16 illustrates a schematic plan view of object 1300 showing how a plurality of microengine assemblies (900a, 900b, 900c) may be attached to object 1300. Each microengine assembly 900 comprises a microengine 905 and a latching unit 910. Each microengine assembly 900 is positioned so that its latching unit 910 may be coupled to object 1300 through an aperture located near an edge of object 1300. Although FIG. 16 illustrates three (3) microengine assemblies (900a, 900b, 900c), the number three is exemplary. It is understood that some number other than three (3) such microengine assemblies may be used. A plurality of microengine assemblies may be used to an object 1300 that is too large for a single microengine assembly to move.

In one advantageous embodiment of the invention, each microengine assembly (900a, 900b, 900c) connected to object 1300 is controlled by a separate controller (not shown in FIG. 16). The separate controllers of each microengine assembly may be themselves, in turn, controlled by a master controller (not shown in FIG. 16). In another advantageous embodiment of the invention, all of the microengine assemblies (900a, 900b, 900c) attached to object 1300 may be directly controlled by a master controller (not shown in FIG. 16).

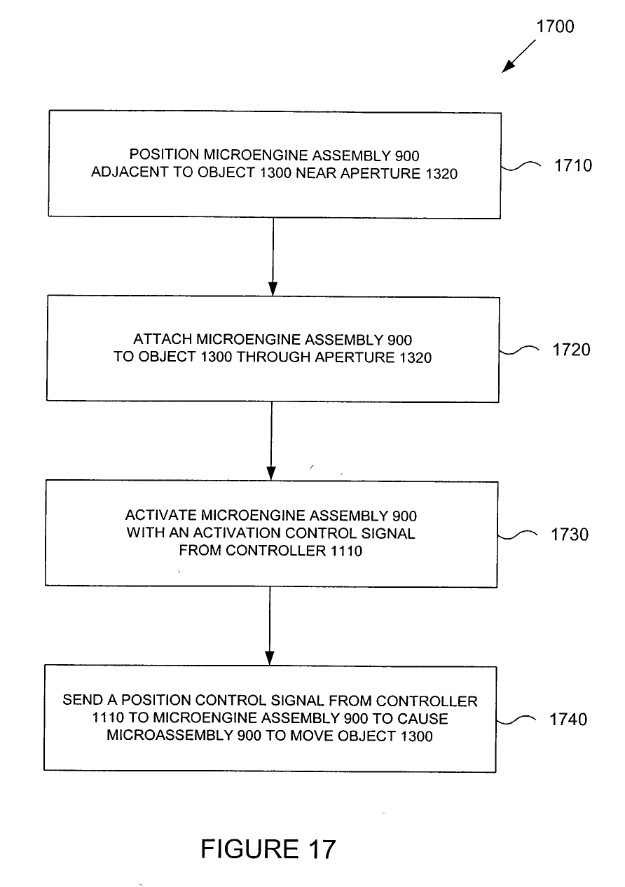

FIG. 17 illustrates a flow diagram of a method for utilizing microengine assembly 900 to move object 1300 in accordance with the principles of the present invention. The steps of the method are collectively referred to with reference numeral 1700.

A microengine assembly 900 is positioned adjacent to an edge of object 1300 near aperture 1320 (step 1710). In particular, microengine assembly 900 is positioned so that latching unit 910 may be coupled to object 1300 through aperture 1320. As previously described, second hinge plate 1240 is passed through aperture 1320 in object 1300 and joined to first hinge plate 1225 of latching unit 910. The joining of the ends of second hinge plate 1240 and first hinge plate 1225 couples latching unit 910 (and microengine assembly 900) object 1300 (step 1720).

In order to move object 1300, voltage is applied to microengine assembly 900 by controller 1110. Controller 1110 sends an activation control signal (such as a voltage signal or a current signal) to activate microengine assembly 900 (step 1730).

Controller 1110 then sends a position control signal (such as a voltage signal or a current signal) to either extend or retract latching unit 910 (step 1740). The extension of latching unit 910 moves object 1300 away from microengine assembly 900. Similarly, the retraction of latching unit 910 moves object 1300 toward microengine assembly 900. The present invention provides a microengine assembly 900 that is capable of moving object 1300 in micron (1 μm) size steps.

The invention having now been fully described, it should be understood that it may be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and all changes which come within the meaning and range of equivalency of the claims are intended to be embraced therein.

What is claimed is:

1. A microengine assembly capable of moving an object, said microengine assembly comprising:
an electrothermally actuated microengine; and
a latching unit coupled to said electrothermally actuated microengine wherein said latching unit is capable of being coupled to said object to connect said microengine assembly to said object.

2. The microengine assembly as claimed in claim 1 further comprising:
a controller coupled to said microengine assembly wherein said controller is capable of sending a control signal to said microengine assembly to cause said microengine assembly to move said object.

3. The microengine assembly as claimed in claim 1 wherein said electrothermally actuated microengine comprises:
a translation unit that comprises:
a slider unit that is capable of being coupled to said latching unit, said slider unit having a first geared edge and a second geared edge;
a first geared pawl that is capable of engaging said first geared edge of said slider unit;
a first engagement member that is capable of engaging said first geared pawl with said first geared edge of said slider unit;
a second geared pawl that is capable of engaging said second geared edge of said slider unit; and
a second engagement member that is capable of engaging said second geared pawl with said second geared edge of said slider unit.

4. The microengine assembly as claimed in claim 3 wherein said electrothermally actuated microengine further comprises:
at least one thermal beam actuator array capable of causing said slider unit to move; and
at least one thermal beam actuator array capable of causing said slider unit to remain in a fixed position.

5. The microengine assembly as claimed in claim 3 wherein said electrothermally actuated microengine further comprises:
a first thermal beam actuator array capable of causing said slider unit to move in a forward direction;
a second thermal beam actuator array capable of causing said slider unit to move in a backward direction;
a third thermal beam actuator array capable of causing said first engagement member to engage said first geared pawl with said first edge of said slider unit to cause said slider unit to be movable by said second thermal beam actuator array; and
a fourth thermal beam actuator array capable of causing said second engagement member to engage said second geared pawl with said second edge of said slider unit to cause said slider unit to be movable by said first thermal beam actuator array.

6. The microengine assembly as claimed in claim 1 wherein said latching unit comprises:
a first hinge plate comprising a distal end having portions that form a plurality of latching windows; and
a second hinge plate comprising a distal end having portions that form a plurality of latching elements, said plurality of latching elements capable of being received within said plurality of latching windows of said first hinge plate to lock together said distal end of said first hinge plate and said distal end of said second hinge plate.

7. The microengine assembly as claimed in claim 1 wherein said electrothermally actuated microengine is capable of moving said latching element by a distance that is greater than ten microns.

8. A micro-electro-mechanical system comprising:
a object having portions that form a plurality of apertures through said object, and wherein said plurality of apertures are located adjacent to an edge of said object; and
a plurality of microengine assemblies coupled to said object through said plurality of apertures in said object, wherein each microengine assembly of said plurality of microengine assemblies is capable of moving said object.

9. The micro-electro-mechanical system as claimed in claim 8 further comprising:
a controller coupled to said plurality of microengine assemblies wherein said controller is capable of sending a control signal to each microengine assembly to cause each microengine assembly of said plurality of microengine assemblies to move said object.

10. The micro-electro-mechanical system as claimed in claim 8 wherein each microengine assembly of said plurality of microengine assemblies comprises:
an electrothermally actuated microengine; and
a latching unit coupled to said electrothermally actuated microengine wherein said latching unit is capable of being coupled to said object to connect said microengine assembly to said object.

11. The micro-electro-mechanical system as claimed in claim 10 wherein said electrothermally actuated microengine comprises:
a translation unit that comprises:
a slider unit that is capable of being coupled to said latching unit, said slider unit having a first geared edge and a second geared edge;
a first geared pawl that is capable of engaging said first geared edge of said slider unit;
a first engagement member that is capable of engaging said first geared pawl with said first geared edge of said slider unit;
a second geared pawl that is capable of engaging said second geared edge of said slider unit; and
a second engagement member that is capable of engaging said second geared pawl with said second geared edge of said slider unit.

12. The micro-electro-mechanical system as claimed in claim 11 wherein said electrothermally actuated microengine further comprises:
at least one thermal beam actuator array capable of causing said slider unit to move; and
at least one thermal beam actuator array capable of causing said slider unit to remain in a fixed position.

13. The micro-electro-mechanical system as claimed in claim 11 wherein said electrothermally actuated microengine further comprises:
a first thermal beam actuator array capable of causing said slider unit to move in a forward direction;
a second thermal beam actuator array capable of causing said slider unit to move in a backward direction;
a third thermal beam actuator array capable of causing said first engagement member to engage said first geared pawl with said first edge of said slider unit to cause said slider unit to be movable by said second thermal beam actuator array; and
a fourth thermal beam actuator array capable of causing said second engagement member to engage said second geared pawl with said second edge of said slider unit to cause said slider unit to be movable by said first thermal beam actuator array.

14. The micro-electro-mechanical system as claimed in claim 10 wherein said latching unit comprises:
a first hinge plate comprising a distal end having portions that form a plurality of latching windows; and
a second hinge plate comprising a distal end having portions 6 that form a plurality of latching elements, said plurality of latching elements capable of being received within said plurality of latching windows of said first hinge plate to lock together said distal end of said first hinge plate and said distal end of said second hinge plate.

15. The micro-electro-mechanical system as claimed in claim 10 wherein said electrothermally actuated microengine is capable of moving said latching element by a distance that is greater than ten microns.

16. A method for using at least one microengine assembly to move an object, said method comprising the steps of:
coupling at least one microengine assembly to an edge of said object wherein said at least one microengine assembly is capable of applying force to said object;
coupling a controller to said at least one microengine assembly; and
sending a control signal from said controller to said at least one microengine assembly to cause said at least one microengine assembly to apply force to said object to move said object.

17. The method as claimed in claim 16 further comprising the steps of:
providing in said at least one microengine assembly an electrothermally actuated microengine that is capable of receiving at least one control signal from said controller;
coupling a latching unit to said electrothermally actuated microengine; and
coupling said latching unit to said object to secure said microengine assembly to said object.

18. The method as claimed in claim 17 further comprising the steps of:
providing in said electrothermally actuated microengine a translation unit that comprises a slider unit that is coupled to said latching unit;
causing said slider unit to move by using at least one thermal beam actuator array; and
causing said slider unit to remain in a fixed position by using at least one thermal beam actuator array.

19. The method as claimed in claim 18 further comprising the steps of:
causing said slider unit to move in a forward direction by using a first thermal beam actuator array;
causing said slider unit to move in a backward direction by using a second thermal beam actuator array;
using a third thermal beam actuator array to cause a first engagement member to engage said slider unit to cause said slider unit to be movable by said second thermal beam actuator array; and
using a fourth thermal beam actuator array to cause a second engagement member to engage said slider unit to cause said slider unit to be movable by said first thermal beam actuator array.

20. The method as claimed in claim 17 further comprising the steps of:
providing in said at least one microengine assembly a latching unit that comprises a first hinge plate comprising a distal end having portions that form a plurality of latching windows and a second hinge plate that comprises a distal end having portions that form a plurality of latching elements;
placing said distal end of said second hinge plate through an aperture of said periphery of said lens;
placing said distal end of said first hinge plate adjacent to said distal end of said second hinge plate;
receiving said plurality of latching elements of said second hinge plate within said plurality of latching windows of said first hinge plate; and
locking together said distal end of said first hinge plate and said distal end of said second hinge plate.

21. The method as claimed in claim 16 further comprising the step of:
moving said object by using said controller to adjust a position of a slider unit in said at least one microengine assembly by a distance that is greater than ten microns.
